(19) United States
(12) Patent Application Publication
(10) Pub. No.: US 2002/0161814 A1
(43) Pub. Date: Oct. 31, 2002

(54) Batch processing system running in parallel on automated and distributed replication systems

(76) Inventor: Kelly J. Wical, St.Augustine, FL (US)

Correspondence Address: DORSEY & WHITNEY, LLP, SUITE 4700, 370 SEVENTEENTH STREET, DENVER, CO, 80202-5647, US

(21) Appl. No.: 09/790,681

(22) Filed: Feb. 23, 2001

Related U.S. Application Data
(60) Provisional application No. 60/237,611, filed on Oct. 4, 2000.

(51) Int. Cl. G06F 9/00

(52) U.S. Cl. 709/101

(57) ABSTRACT

Batch processing in an automated and distributed replication system for managing electronic transactions over the Internet or other type of network. Batch transactions are executed on one machine and posted to replicated machines via a message queue. In the event of machine failure, one of the replicated machines takes over processing of the batch transactions posted from the failed machine. Batch tables maintain a status for each of the transactions to manage the processing of them among the machines.

### REFERENCE TO RELATED APPLICATIONS

The present application is related to the following applications, all of which are incorporated herein by reference as if fully set forth: United States provisional patent application of Kelly Wical, entitled “Apparatus and Method for Managing Electronic Commerce Transactions in an Automated and Distributed Replication System,” and filed on Oct. 4, 2000; United States patent application of Kelly Wical, entitled “Switched Session Management Using Local Persistence in an Automated and Distributed Replication System,” and filed on even date herewith; and United States patent application of Kelly Wical, entitled “Caching System Using Timing Queues Based on Last Access Times,” and filed on even date herewith.

### FIELD OF THE INVENTION

The present invention relates to an apparatus and method for managing electronic transactions within automated and distributed replication systems and other environments. It relates more particularly to a batch processing system running in parallel on the automated and distributed replication systems or other environments.

### BACKGROUND OF THE INVENTION

Systems for processing electronic transactions often include multiple levels of redundancy of servers and other machines. The redundancy means that, if one machine fails, other machines may take over processing for it. In addition, use of multiple levels of machines provides for distributing a load across many machines to enhance the speed of processing for users or others. The use of multiple levels of machines requires management of processing among them.

For example, each machine typically may have its own local cache and other stored data in memory. Management of a local cache in memory typically must be coordinated with the cache and memory of the other machines processing all of the electronic transactions. Therefore, use of multiple machines and levels requires coordination and synchronization among the machines in order to most effectively process electronic transactions without errors.

### SUMMARY OF THE INVENTION

An apparatus and method consistent with the present invention performs batch processing of transactions in an automated and distributed replication system. A first batch transaction is received from a client and assigned a first status. A second batch transaction is received from a replicated entity and assigned a second status. The first and second batch transactions are processed based upon the first and second statuses.

Another apparatus and method consistent with the present invention also performs batch processing of transactions in an automated and distributed replication system. A first batch transaction is received by a machine acting as a host machine, and the first batch transaction is assigned a first status. A second batch transaction is received by a machine acting as a standby machine, and the second batch transaction is assigned a second status. Upon posting the first batch transaction for processing, the first status is changed and an indication of that change is provided to replicated machines. Upon receiving an indication of a posting of the second batch transaction, the second status is changed based upon the indication of the posting.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of an exemplary automated and distributed replication system for processing electronic transactions;

FIG. 2 is a diagram of exemplary components of machines in the automated and distributed replication system;

FIG. 3 is a diagram of exemplary components used within the machines for batch processing of electronic transactions;

FIG. 4 is a flow chart of a main job processing routine for batch processing;

FIG. 5 is a flow chart of a post jobs routine for batch processing;

FIG. 6 is a flow chart of a fail over routine for batch processing; and

FIG. 7 is a flow chart of a routine for a failed machine to come back on-line.

### DETAILED DESCRIPTION

### Automated and Distributed Replication System

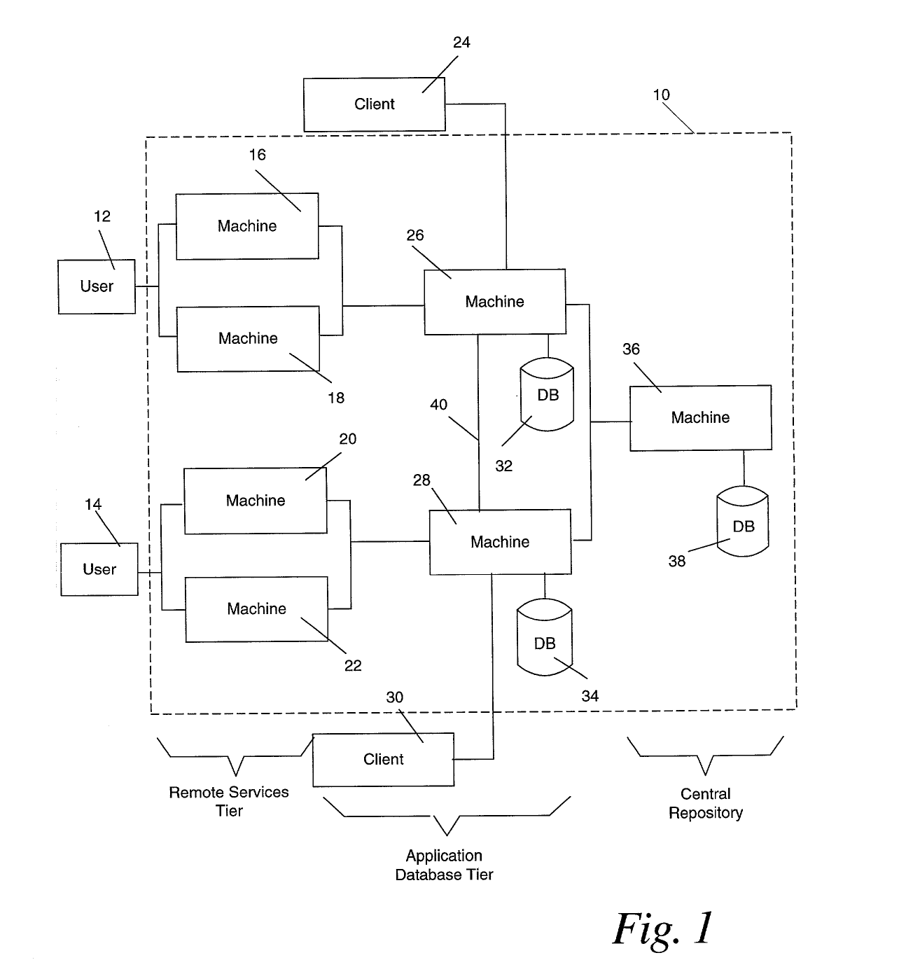

FIG. 1 is a diagram of an example of an automated and distributed replication system 10 for processing electronic transactions. System 10 includes machines 16 and 18 for processing electronic transactions from a user 12, and machines 20 and 22 for processing electronic transactions from a user 14. Users 12 and 14 are each shown connected to two machines for illustrative purposes only; the user would typically interact at a user machine with only one of the machines (16, 18, 20, 22) and would have the capability to be switched over to a different machine if, for example, a machine fails. Users 12 and 14 may interact with system 10 via a browser, client program, or agent program communicating with the system over the Internet or other type of network.

Machines 16 and 18 interact with a machine 26, and machines 20 and 22 interact with a machine 28. Machines 26 and 28 can communicate with each other as shown by connection 40 for processing electronic transactions, and for coordinating and synchronizing the processing. In addition, machine 26 can receive electronic transactions directly from a client 24 representing a client machine or system. Machine 28 can likewise receive electronic transactions directly from a client 30. Clients 24 and 30 may communicate with system 10 over the Internet or other type of network.

Machines 26 and 28 interact with a machine 36, which functions as a central repository. Machines 26 and 28 form an application database tier in system 10, and machines 16, 18, 20 and 22 form a remote services tier in system 10. Each machine can include an associated database for storing information, as shown by databases 32, 34, and 38. System 10 can include more or fewer machines in each of the tiers and central repository for additional load balancing and processing for electronic transactions. The operation and interaction of the various machines can be controlled in part through a properties file, also referred to as an Extensible Markup Language (XML) control file, an example of which is provided in the related provisional application identified above.

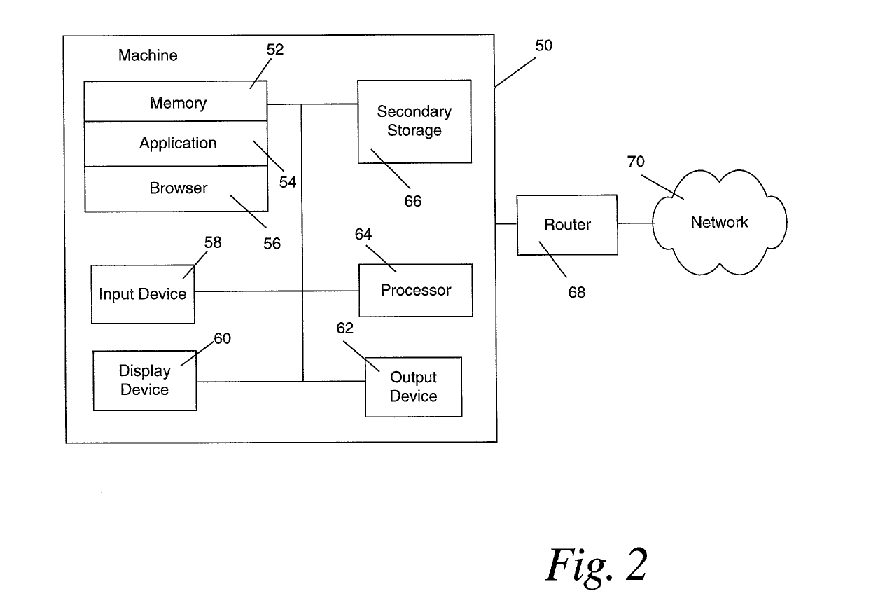

FIG. 2 is a diagram of a machine 50 illustrating exemplary components of the machines shown and referred to in FIG. 1. Machine 50 can include a connection with a network 70 such as the Internet through a router 68. Network 70 represents any type of wireline or wireless network. Machine 50 typically includes a memory 52, a secondary storage device 66, a processor 64, an input device 58, a display device 60, and an output device 62.

Memory 52 may include random access memory (RAM) or similar types of memory, and it may store one or more applications 54 and possibly a web browser 56 for execution by processor 64. Applications 54 may correspond with software modules to perform processing for embodiments of the invention such as, for example, agent or client programs. Secondary storage device 66 may include a hard disk drive, floppy disk drive, CD-ROM drive, or other types of non-volatile data storage. Processor 64 may execute applications or programs stored in memory 52 or secondary storage 66, or received from the Internet or other network 70. Input device 58 may include any device for entering information into machine 50, such as a keyboard, key pad, cursor-control device, touch-screen (possibly with a stylus), or microphone.

Display device 60 may include any type of device for presenting visual information such as, for example, a computer monitor, flat-screen display, or display panel. Output device 62 may include any type of device for presenting a hard copy of information, such as a printer, and other types of output devices include speakers or any device for providing information in audio form. Machine 50 can possibly include multiple input devices, output devices, and display devices. It can also include fewer components or more components, such as additional peripheral devices, than shown depending upon, for example, particular desired or required features of implementations of the present invention.

Router 68 may include any type of router, implemented in hardware, software, or a combination, for routing data packets or other signals. Router 68 can be programmed to route or redirect communications based upon particular events such as, for example, a machine failure or a particular machine load.

Examples of user machines, represented by users 12 and 14, include personal digital assistants (PDAs), Internet appliances, personal computers (including desktop, laptop, notebook, and others), wireline and wireless phones, and any processor-controlled device. The user machines can have, for example, the capability to display screens formatted in pages using browser 56, or client programs, and to communicate via wireline or wireless networks.

Although machine 50 is depicted with various components, one skilled in the art will appreciate that this machine can contain different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). The computer-readable media may include instructions for controlling machine 50 to perform a particular method.

### Batch Processing System Running in Parallel on Automated and Distributed Replication Systems

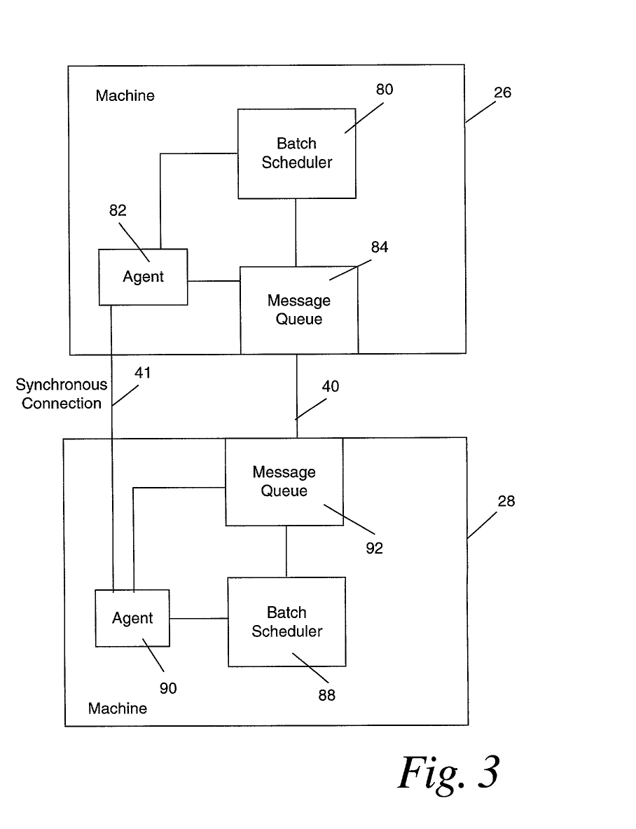

FIG. 3 is a diagram of exemplary components of machines 26 and 28 used for batch processing in automated and distributed replication system 10. Batch processing can occur directly with the machines in the application database, for example, as shown by clients 24 and 30 in FIG. 1, since the batch jobs usually do not require processing of pages, for example, and thus need not traverse the remote services tier. Batch jobs can be formatted, for example, in XML as name-value pairs. In addition to external batch jobs arriving into the system, it can also process internal batch jobs transmitted from the system such as e-mail confirmation messages or other information.

As an example of processing batch jobs, consider the following. An exemplary batch job includes a list of one hundred loans having address or phone number changes to be updated in a loan processing system. Each loan is sent to a mortgage company for processing. At midnight, the mortgage company sends the batch of one hundred loans with the updated addresses or phone numbers to the system, which executes batch job processing to make the changes. This is only one example, and embodiments consistent with the present invention can process any type of batch jobs.

Batch processing of electronic transactions uses host machines and standby machines. The host machines are the intended machines for processing batch transactions, and the standby machines process the transactions if the host machine fails. To accomplish this processing, the machines include the following exemplary entities. Machine 26 includes a batch scheduler 80 controlled by an agent program 82. Batch scheduler 80 interacts with a message queue 84. Machine 28 likewise includes a batch scheduler 88 controlled by an agent program 90, and batch scheduler 88 interacts with a message queue 92. Message queue 84 and message queue 92 in the machines can interact via connection 40. The agent programs 82 and 90 can interact via a synchronous real-time connection 41 to exchange status information concerning batch job processing. The agents and batch schedulers can be implemented, for example, by software programs executed by processors in the corresponding machines. Message queues 84 and 92 can be implemented with any type of buffer or local memory for holding data.

Using the entities shown in FIG. 3, batch processing occurs as follows. When a machine receives a job, it is a list of smaller transactions that must be individually posted. The system creates the individual jobs on the host machine, and then sends each of the individual jobs to the standby machines, which sets them up with a standby status. The host machine posts the jobs from information in the batch queue. As it posts each job, the host machine sends all the information for that transaction to the standby machines through the queue. The standby machines post the transactions from the queue, and update the batch status for each transaction. The standby machines end up with two copies of the data, one in the batch job and the other in the queue. A particular standby machine does not use the copy in the batch job unless it becomes the host machine; rather, it deletes that copy when it posts the real copy out of the queue.

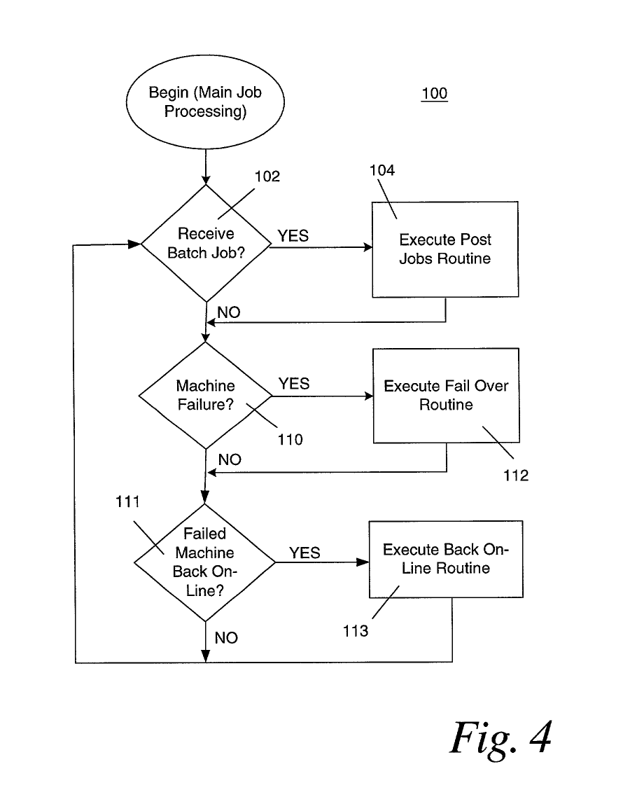

FIG. 4 is a flow chart of a main job processing routine 100 using the exemplary components as shown in FIG. 3 and further illustrating batch processing of electronic transactions. Routine 100 and the routines described below may be implemented, for example, in software modules for execution by each of the machines 26 and 28. In routine 100, the system as implemented with the agents and batch schedulers determines if it has received a batch job (step 102); if so, it executes a post jobs routine (step 104). The system also determines if a machine has failed (step 110); if so, it executes a fail over routine (step 112). If the system detects that a failed machine comes back on-line (step 111), it executes a back on-line routine for the machine (step 113).

Batch jobs are assigned a particular status for processing, as summarized in Table 1 and further explained below. The names of the statuses identified in Table 1 are intended as labels only, and different labels can define statuses having the same meaning.

TABLE 1

| status | processing to be performed for the corresponding job |
|---|---|
| A | active, ready to be posted |
| S | standby, posting on another host machine |
| C | posting complete, ready to send notification to the client |
| X | posting complete on standby machine(s), |
| | but do not send notification to the client |
| F | final, notification sent to the client |

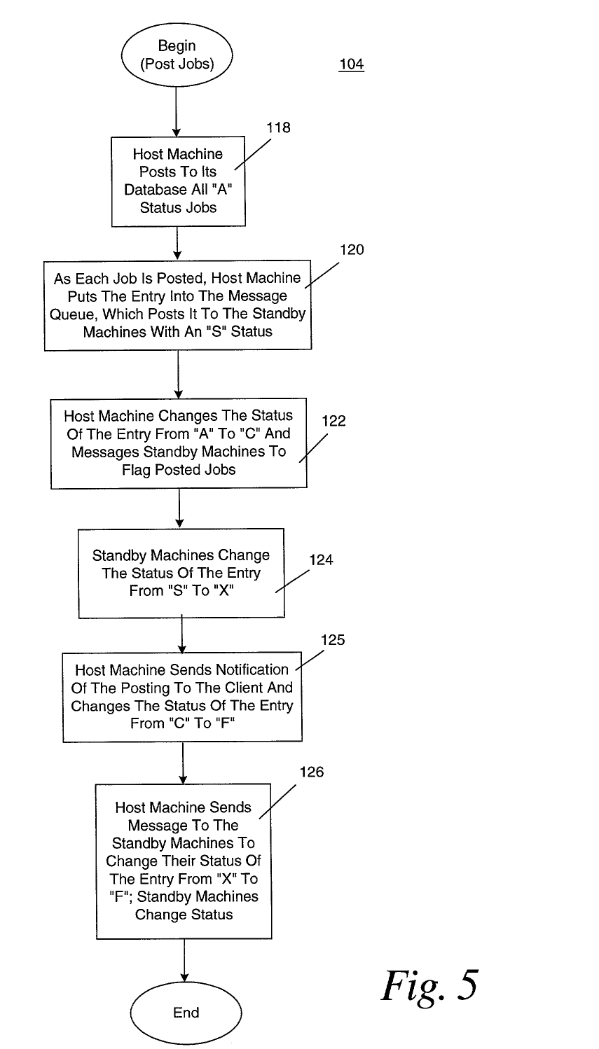

FIG. 5 is a flow chart of post jobs routine 104. In routine 104, the host machine posts to its database all jobs having an “A” status (step 118). As the host machine posts each job, it puts the entry for the job in the message queue, which then posts the entry to the standby machines with an “S” status (step 120). The host machine changes the status of the host entry from “A” to “C” after posting (step 122). The host machine also messages the standby machines on synchronous real-time connection 41 to flag the posted items (step 122). As further explained below, this messaging is used to accommodate potential time delays between processing and posting jobs on the host machine.

Upon receiving the message to post the data from the host machine via the message queue, the standby machines change the status of the entry from “S” to “X” in their batch tables (step 124). The host machine also sends notification of the posting to the client and changes the status of the entry from “C” to “F” to indicate that the notification has occurred (step 125). The host machine sends a message to the standby machines to change their status of the entry from “X” to “F” after the posting, and the standby machines make the change in status in their batch tables (step 126).

Tables 2 and 3 illustrate an example of batch tables for the machines as maintained by the batch schedulers. The batch tables can be stored electronically in any type of data 5 structure. As shown in Table 2, each row represents a transaction. The entries 1.1, 1.2, and 1.3 represent job 1 received at machine 1. The entries 2.1 and 2.2 represent job 2 received from another machine in order to replicate the data. Job 1 has an “A” status since machine 1 is the host machine for processing it, and job 2 has an “S” status since a different machine is the host machine for that job, meaning that machine 1 is a standby machine for job 2.

Table 3 illustrates how job 1 from machine 1 is recorded in the batch table for machine 2 in order to replicate the data in the event of machine failure. Job 1 has an “S” status in the machine 2 batch table since a different machine is the host for that job and, therefore, machine 2 is a standby machine for job 1. Job 3 (entries 3.1 and 3.2) simply represents a job entered into machine 2 as host machine.

TABLE 2
batch scheduler (machine 1)

| job entry | data | status flag |
|---|---|---|
| 1.1 | data 1.1 | active (A) |
| 1.2 | data 1.2 | active (A) |
| 1.3 | data 1.3 | active (A) |
| 2.1 | data 2.1 | standby (S) |
| 2.2 | data 2.2 | standby (S) |

TABLE 3
batch scheduler (machine 2)

| job entry | data | status flag | |
|---|---|---|---|
| 3.1 | data 3.1 | active | (A) |
| 3.2 | data 3.2 | active | (A) |
| 1.1 | data 1.1 | standby | (S) |
| 1.2 | data 1.2 | standby | (S) |
| 1.3 | data 1.3 | standby | (S) |

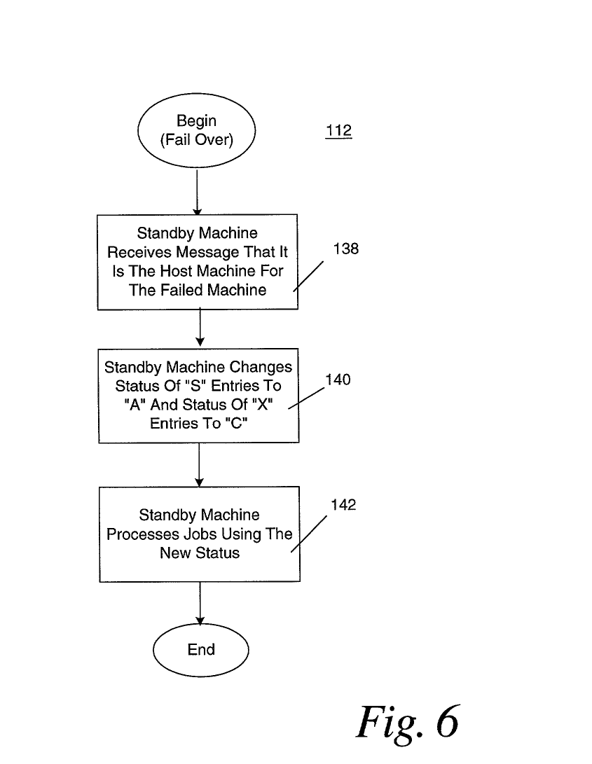

FIG. 6 is a flow chart of fail over routine 112. In routine 112, a standby machine receives a message that it is the host machine for the failed machine (step 138). The central repository can detect when a machine has failed. The properties file, for example, can maintain an indication of which machines take over processing for failed machines so that the central repository can message a particular machine to take over processing. Other methodologies can alternatively be used to switch processing upon detection of a machine failure. The standby machine, now the host machine for the failed machine, changes the status of the “S” entries to “A” and changes the status of the “X” entries to “C” in its batch table for those entries corresponding to the failed machine (step 140). The standby machine can then perform normal job processing, as described in routine 104, using the new status of the entries for the failed machine (step 142).

When a machine takes over as host machine in fail over routine 112, it need not return processing to the failed machine when that machine comes back on-line. In this exemplary embodiment as illustrated in FIGS. 1 and 3, the machines are not configured in an hierarchical relationship. Therefore, when a machine takes over processing as host machine, it processes the batch jobs for which it is the host machine and posts the jobs without the need to return processing to another machine. Alternatively, processing can return to the original host machine with appropriate configuration of the system.

Table 4 illustrates an example of the change in status for job 1 in the machine 2 batch table upon machine 2 performing processing for machine 1 jobs. In this example, job entry 1.1 was already finished and thus maintains an “F” status. Job entry 1.2 was already processed and its status changes to “C,” meaning that machine 2 can post it to a receiving machine such as, for example, a machine in the application database. Job entry 1.3 was on “S” status and had not yet been processed; therefore its status changes to “A” in order to be processed by machine 2.

TABLE 4
batch scheduler (machine 2)-fail over

| job entry | data | status flag |
|---|---|---|
| . . . | | |
| 1.1 | data 1.1 | (F) |
| 1.2 | data 1.2 | (X)→(C) |
| 1.3 | data 1.3 | (S)→(A) |

Upon change to “F” status, the original host machine for the jobs can report them to the client. The status flags are also, for example, written in a two-phase commit mode to the standby systems, in parallel to the posting of the queue. This allows the standby machine to know that a transaction has been processed, even if the host machine fails and cannot post the transaction to the standby machine through the queue. The use of the various types of status flags ensures that the client receives only one notification that the transactions were processed, rather than multiple notifications from the various machines that have recorded the transactions.

Table 5 illustrates the use of synchronous real-time connection 41 in step 122. This example contains five data changes for machine 1 as host. As machine 1 processes each data change, it messages machine 2 on the synchronous real-time connection to flag the posted job. Consider, for example, that machine 1 fails after processing the job for data change 3 but before it can post the job. Without the synchronous real-time connection, machine 2 would not detect that data change 3 had been processed and may begin with that job as host machine, which would result in the data change being processed twice. However, machine 2 detects on the synchronous real-time connection the messaging to post data change 3 and therefore determines that it should begin processing as host machine with data change 4. Accordingly, the messaging on the synchronous real-time connection compensates for time delays between processing and posting of batch jobs in this exemplary embodiment. Alternatively, other embodiments can perform the batch processing without the synchronous messaging and permit potential multiple processing of jobs.

TABLE 5

| data | action | flag |
|---|---|---|
| 1 | machine 1 processes data change and posts to machine 2 | P-1 |
| 2 | machine 1 processes data change and posts to machine 2 | P-2 |
| 3 | machine 1 processes data change but fails before posting; | P-3 |
| | machine 2 detects flag P-3 for data 3 and starts processing | |
| | with data 4 | |
| 4 | machine 2 processes data change and posts to machine 1 | |
| 5 | machine 2 processes data change and posts to machine 1 | |

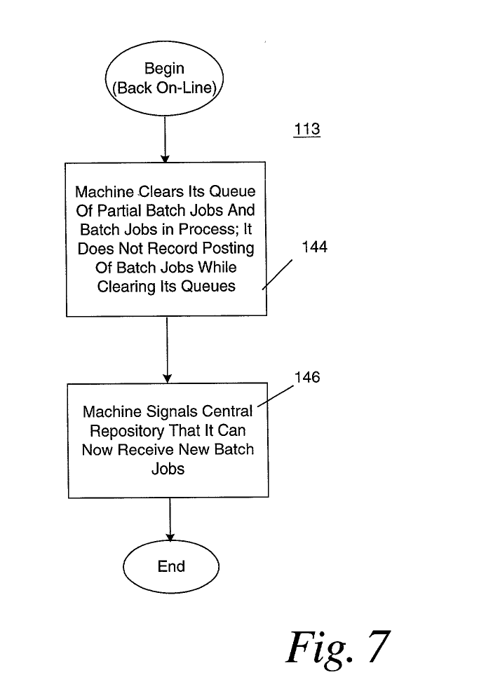

FIG. 7 is a flow chart of routine 113 for a failed machine to come back on-line. When a failed machine comes back on-line, it clears its queue of partial batch jobs and batch jobs in process (step 144). During the time when the machine failed, it may have not received all information required for batch jobs and, therefore, its batch tables may be incomplete. Instead of attempting to complete the partial batch jobs, the machine can clear its queue and not function as a standby machine for those partial batch jobs. Other machines in the system can function as standby machines for those partial batch jobs and the failed machine thus need not be a standby machine for them. During the time that it clears its queue, the machine coming back on-line does not record, and thus “ignores,” any batch jobs posted to it. Once it has cleared its queues, the machine signals the central repository that it is back on-line and can now receive batch jobs (step 146); it can also now function as a standby machine for the new batch jobs that it will receive. Therefore, to function as a standby machine in this exemplary embodiment, a machine must be on-line (not in a failed state) and must have been on-line from the beginning of posting of the batch job so that it has all required information for the batch job.

While the present invention has been described in connection with an exemplary embodiment, it will be understood that many modifications will be readily apparent to those skilled in the art, and this application is intended to cover any adaptations or variations thereof. For example, different labels for the various modules and databases, and various hardware embodiments for the machines, may be used without departing from the scope of the invention. This invention should be limited only by the claims and equivalents thereof.

1. A method for performing batch processing of transactions in an automated and distributed replication system, comprising:
receiving a first batch transaction from a client;
receiving a second batch transaction from a replicated entity;
assigning a first status to the first batch transaction and a second status to the second batch transaction; and
processing the first and second batch transactions based upon the first and second statuses.

2. The method of claim 1 wherein:
the assigning step includes assigning a complete status to the first batch transaction; and
the processing step includes posting the first batch transaction to a database.

3. The method of claim 2 wherein:
the assigning step includes assigning a finished status to the first batch transaction; and
the processing step includes providing notification of the posting.

4. The method of claim 2, further including posting an indication of the first batch transaction to the replicated entity with a standby status.

5. The method of claim 3, further including posting an indication of the first batch transaction to the replicated entity with the finished status.

6. The method of claim 1, further including receiving a complete status for the second batch transaction and wherein the assigning step includes assigning a standby status to the second batch transaction.

7. The method of claim 1, further including receiving an indication of a host machine status for the second batch transaction.

8. The method of claim 7, further including detecting a standby status for the second batch transaction and wherein the assigning step includes changing the standby status to an active status for the second batch transaction.

9. The method of claim 7, further including detecting a posting complete status for the second batch transaction as a standby machine and wherein the assigning step includes changing the posting complete status to a complete status as the host machine for the second batch transaction.

10. The method of claim 1, further including:
posting the first batch transaction; and
placing an entry into a message queue for the first batch transaction, wherein the entry indicates the status for the first batch transaction.

11. The method of claim 1, further including messaging on a synchronous real-time connection an indication of the processing.

12. A method for performing batch processing of transactions in an automated and distributed replication system, comprising:
receiving as a host machine a first batch transaction;
receiving as a standby machine a second batch transaction;
assigning a first status to the first batch transaction and a second status to the second batch transaction;
posting the first batch transaction for processing, changing the first status, and providing an indication of the change in the first status; and
receiving an indication of a posting of the second batch transaction and changing the second status based upon the indication of the posting.

13. The method of claim 12 wherein:
the assigning step includes assigning an active status to the first batch transaction; and
the posting step includes changing the active status to a complete status.

14. The method of claim 12 wherein:
the assigning step includes assigning a standby status to the second batch transaction; and
the receiving the indication step includes changing the standby status to a complete status.

15. The method of claim 12, further including receiving an indication of a change to the host machine for the second batch transaction.

16. The method of claim 15 wherein the assigning step includes:
assigning a standby status to the second batch transaction; and
changing the standby status for the second batch transaction to an active status in response to the indication of the change to the host machine.

17. An apparatus for performing batch processing of transactions in an automated and distributed replication system, comprising:
a receive module for receiving a first batch transaction from a client and a second batch transaction from a replicated entity;
an assign module for assigning a first status to the first batch transaction and a second status to the second batch transaction; and
a process module for processing the first and second batch transactions based upon the first and second statuses.

18. The apparatus of claim 17 wherein:
the assign module includes a module for assigning a complete status to the first batch transaction; and
the process module includes a module for posting the first batch transaction to a database.

19. The apparatus of claim 18 wherein:
the assign module includes a module for assigning a finished status to the first batch transaction; and
the process module includes a module for providing notification of the posting.

20. The apparatus of claim 18, further including a module for posting an indication of the first batch transaction to the replicated entity with a standby status.

21. The apparatus of claim 19, further including a module for posting an indication of the first batch transaction to the replicated entity with the finished status.

22. The apparatus of claim 17, further including a module for receiving a complete status for the second batch transaction and wherein the assign module includes a module for assigning a standby status to the second batch transaction.

23. The apparatus of claim 17, further including a module for receiving an indication of a host machine status for the second batch transaction.

24. The apparatus of claim 23, further including a module for detecting a standby status for the second batch transaction and wherein the assign module includes a module for changing the standby status to an active status for the second batch transaction.

25. The apparatus of claim 23, further including a module for detecting a posting complete status for the second batch transaction as a standby machine and wherein the assign module includes a module for changing the posting complete status to a complete status as the host machine for the second batch transaction.

26. The apparatus of claim 17, further including:
a module for posting the first batch transaction; and
a module for placing an entry into a message queue for the first batch transaction, wherein the entry indicates the status for the first batch transaction.

27. The apparatus of claim 1, further including a module for messaging on a synchronous real-time connection an indication of the processing.

28. An apparatus for performing batch processing of transactions in an automated and distributed replication system, comprising:
a receive module for receiving as a host machine a first batch transaction and for receiving as a standby machine a second batch transaction;
an assign module for assigning a first status to the first batch transaction and a second status to the second batch transaction;
a host machine module for posting the first batch transaction for processing, changing the first status, and providing an indication of the change in the first status; and
a standby machine module for receiving an indication of a posting of the second batch transaction and changing the second status based upon the indication of the posting.

29. The apparatus of claim 28 wherein:
the assign module includes a module for assigning an active status to the first batch transaction; and
the host machine module includes a module for changing the active status to a complete status.

30. The apparatus of claim 28 wherein:
the assign module includes a module for assigning a standby status to the second batch transaction; and
the standby machine module includes a module for changing the standby status to a complete status.

31. The apparatus of claim 28, further including a module for receiving an indication of a change to the host machine for the second batch transaction.

32. The apparatus of claim 31 wherein the assign module includes:
a module for assigning a standby status to the second batch transaction; and
a module for changing the standby status for the second batch transaction to an active status in response to the indication of the change to the host machine.
